(19) United States
(12) Patent Application Publication
(10) Pub. No.: US 2021/0027162 A1
(43) Pub. Date: Jan. 28, 2021

(54) Neural Network Model, Data Processing Method, and Processing Apparatus

(71) Applicant: Huawei Technologies Co., Ltd., Shenzhen (CN)

(72) Inventors: Fan Yang, Shenzhen (CN); Chenglin Zheng, Shenzhen (CN)

(21) Appl. No.: 17/068,358

(22) Filed: Oct. 12, 2020

Related U.S. Application Data
(63) Continuation of application No. PCT/CN2019/085885, filed on May 7, 2019.

(30) Foreign Application Priority Data
May 15, 2018 (CN) 201810464380.2

(51) Int. Cl. G06N 3/08; G06N 3/04; G06F 7/544

(52) U.S. Cl. CPC G06N 3/08; G06F 7/5443; G06N 3/0472

(57) ABSTRACT

A neural network model of M network layers, a data processing method, and a processing apparatus configured to execute N tasks, where an i^{th} network layer has a shared weight value to execute each of the N tasks and N groups of dedicated weight values, where each of the N groups of dedicated weight values executes one of the N tasks, all the groups of dedicated weight values are in a one-to-one correspondence with the N tasks, M is a positive integer and 1≤i≤M, when executing a first task, the i^{th} network layer is configured to obtain input data, obtain output data based on a t^{th} group of dedicated weight values, the shared weight value, and the input data, when 1≤i≤M, transmit the output data to an (i+1)^{th} network, where the t^{th} group of dedicated weight values corresponds to the first task, and when i=M, output the output data.

### CROSS-REFERENCE TO RELATED APPLICATIONS

This application is a continuation of International Patent Application No. PCT/CN2019/085885 filed on May 7, 2019, which claims priority to Chinese Patent Application No. 201810464380.2 filed on May 15, 2018. The disclosures of the aforementioned applications are hereby incorporated by reference in their entireties.

### TECHNICAL FIELD

Embodiments of this application relate to the field of computer technologies, and in particular, to a neural network model, a data processing method, and a processing apparatus.

### BACKGROUND

A neural network model is an operation model obtained through interconnection between a large quantity of nodes (or neurons). A common neural network model includes an input layer, an output layer, and a plurality of hidden layers. Output of any hidden layer serves as input of a next layer (another hidden layer or output layer) of the hidden layer. Each layer other than the output layer in the neural network model may perform calculation on input data of the layer based on a corresponding parameter set (for example, a weight value), to generate output data.

A convolutional neural network (CNN) model is one of neural network models. The CNN model has made remarkable achievements in application fields such as image recognition, voice processing, and intelligent robots. A CNN model processing a plurality of tasks has a relatively strong generalization capability such that resources occupied by each task and storage costs can be appropriately reduced.

### SUMMARY

Embodiments of this application provide a neural network model, a data processing method, and a processing apparatus, to resolve a problem that a neural network model has poor performance when processing different tasks.

To achieve the foregoing objective, the following technical solutions are used in this application.

According to a first aspect, a neural network model is provided. The neural network model is configured to execute N (N is an integer greater than or equal to 2) tasks, the N tasks include a first task, the neural network model includes M (M is a positive integer) network layers, the i^{th} (1≤i≤M, and i is an integer) network layer in the M network layers has a shared weight value and N groups of dedicated weight values, the shared weight value herein is used to execute each of the N tasks, each of the N groups of dedicated weight values is used to execute one of the N tasks, and all the groups of dedicated weight values are in a one-to-one correspondence with the N tasks. When executing the first task, the i^{th} network layer is configured to obtain input data, obtain output data based on the t^{th} (1≤t≤N, and t is a n integer) group of dedicated weight values, the shared weight value, and the obtained input data, and when 1≤i≤M, transmit the output data to the (i+1)^{th} network layer in the M network layers, where the t^{th} group of dedicated weight values corresponds to the first task, or when i=M, output the output data.

Each of the N groups of dedicated weight values of the i^{th} network layer is used to execute one of the N tasks, and all the groups of dedicated weight values are in a one-to-one correspondence with the N tasks. Therefore, for any task, when performing data processing, the i^{th} network layer only needs to obtain the shared weight value and a dedicated weight value corresponding to the current task, without obtaining a dedicated weight value corresponding to another task such that performance of the i^{th} network layer is effectively improved, and performance of the neural network model is further improved.

In addition, the shared weight value is used to execute each of the N tasks. Therefore, in a scenario of task switching, the i^{th} network layer only needs to obtain a dedicated weight value corresponding to a current task, without re-obtaining the shared weight value such that a quantity of data read times is reduced, and processing performance is improved.

Optionally, in a possible implementation of this application, the i^{th} network layer is any one of a convolutional layer, a fully connected layer, a deconvolution layer, and a recurrent layer.

In actual application, the i^{th} network layer may be a convolutional layer, a fully connected layer, a deconvolution layer, or a recurrent layer, and this is not limited in this application.

Optionally, in another possible implementation of this application, the output data includes shared output data and dedicated output data. The “obtaining output data based on the t^{th} group of dedicated weight values, the shared weight value, and the obtained input data” is performed using the following method When the i^{th} network layer is a convolutional layer, convolution calculation is performed on the input data using the shared weight value to obtain the shared output data, and convolution calculation is performed on the input data using the t^{th} group of dedicated weight values to obtain the dedicated output data. When the i^{th} network layer is a fully connected layer, multiply-add calculation is performed on the input data using the shared weight value to obtain the shared output data, and multiply-add calculation is performed on the input data using the t^{th} group of dedicated weight values to obtain the dedicated output data. When the i^{th} network layer is a deconvolution layer, transposed convolution calculation is performed on the input data using the shared weight value to obtain the shared output data, and transposed convolution calculation is performed on the input data using the tt group of dedicated weight values to obtain the dedicated output data.

It can be learned that the i^{th} network layer performs calculation on the input data using different calculation methods based on an attribute change of the i^{th} network layer.

According to a second aspect, a data processing method is provided. In the data processing method, the neural network model according to any one of the first aspect and the possible implementations of the first aspect is used to perform data processing. Further, the data processing method is obtaining a first to-be-processed object, and after a first processing operation that is used to instruct to execute a first task on the first to-be-processed object and that is input by a user is received, in response to the first processing operation, obtaining the t^{th} group of dedicated weight values, a shared weight value, and first input data in the i^{th} network layer, obtaining first output data based on the t^{th} group of dedicated weight values, the shared weight value, and the first input data, and transmitting the first output data, where when 1≤i≤M, the first input data is data output after the (i−1)^{th} network layer in M network layers processes the first to-be-processed object, or when i=1, the first input data is data of the first to-be-processed object, and then obtaining a second to-be-processed object, and after a second processing operation that is used to instruct to execute a second task on the second to-be-processed object and that is input by the user is received, in response to the second processing operation, obtaining the q^{th} group of dedicated weight values and second input data in the i^{th} network layer, obtaining second output data based on the q^{th} group of dedicated weight values, the second input data, and the obtained shared weight value, and transmitting the second output data, where the q^{th} group of dedicated weight values are dedicated weight values in the i^{th} network layer that uniquely correspond to the second task, N≥q≥1, q≠t, q is an integer, when 1<i≤M, the second input data is data output after the (i−1)^{th} network layer processes the second to-be-processed object, or when i=1, the second input data is data of the second to-be-processed object, the second task is one of N tasks, and the second task is different from the first task.

With reference to the foregoing description of the first aspect, it can be learned that the i^{th} network layer in the neural network provided in this application has the shared weight value and N groups of dedicated weight values, the shared weight value is used to execute each of the N tasks, each of the N groups of dedicated weight values is used to execute one of the N tasks, and all the groups of dedicated weight values are in a one-to-one correspondence with the N tasks. In a scenario of switching from the first task to the second task, because the shared weight value is used to execute each of the N tasks, a processing apparatus does not need to re-obtain the shared weight value in the i^{th} network layer. Correspondingly, because all the groups of dedicated weight values are in a one-to-one correspondence with the N tasks, the processing apparatus needs to re-obtain a dedicated weight value corresponding to a current task in the i^{th} network layer. The processing apparatus does not need to repeatedly obtain the shared weight value such that a quantity of data read times is effectively reduced, and processing performance is improved.

According to a third aspect, a data processing method is provided. In the data processing method, the neural network model according to any one of the first aspect and the possible implementations of the first aspect is used to perform data processing. The foregoing image denoising task is an image denoising task. Further, the data processing method is obtaining a first to-be-processed image, and after a first processing operation that is used to instruct to execute the image denoising task on the first to-be-processed image and that is input by a user is received, in response to the first processing operation, obtaining the t^{th} group of dedicated weight values, a shared weight value, and first input data in the i^{th} network layer, obtaining first output data based on the t^{th} group of dedicated weight values, the shared weight value, and the first input data, and transmitting the first output data, where when 1<i≤M, the first input data is data output after the (i−1)^{th} network layer in M network layers processes the first to-be-processed image, or when i=1, the first input data is data of the first to-be-processed image, and then obtaining a second to-be-processed image, and after a second processing operation that is used to instruct to execute an image recognition task on the second to-be-processed image and that is input by the user is received, in response to the second processing operation, obtaining the q^{th} group of dedicated weight values and second input data in the i^{th} network layer, obtaining second output data based on the q^{th} group of dedicated weight values, the second input data, and the obtained shared weight value, and transmitting the second output data, where the q^{th} group of dedicated weight values are dedicated weight values in the i^{th} network layer that uniquely correspond to the image recognition task, N≥q≥1, q≠t, and q is an integer, and when 1<i≤M, the second input data is data output after the (i−1)^{th} network layer processes the second to-be-processed image, or when i=1, the second input data is data of the second to-be-processed image, and the image recognition task is one of N tasks.

In a scenario of switching from the image denoising task to the image recognition task, because the shared weight value is used to execute each of the N tasks, a processing apparatus does not need to re-obtain the shared weight value in the i^{th} network layer. Correspondingly, because all the groups of dedicated weight values are in a one-to-one correspondence with the N tasks, the processing apparatus needs to re-obtain a dedicated weight value corresponding to a current task in the i^{th} network layer. The processing apparatus does not need to repeatedly obtain the shared weight value such that a quantity of data read times is effectively reduced, and processing performance is improved.

According to a fourth aspect, a method for training a neural network model is provided. The neural network model is the neural network model according to any one of the first aspect and the possible implementations of the first aspect. Further, the training method is obtaining training information that includes K (K is a positive integer) training objects and marking information of each of the K training objects, performing a training processing operation based on the obtained training information, where the training processing operation is “inputting the K training objects into the neural network model to obtain K processing results, where each of the K processing results uniquely corresponds to one training object, determining K difference values, where each of the K difference values represents a difference between each processing result and marking information of a training object corresponding to the processing result, performing calculation on a difference values in the K difference values according to a preset statistical algorithm, to obtain a first statistical error, where a training object corresponding to each of the a difference values is used to execute a first task, 0≤a≤K, and a is an integer, performing calculation on b difference values in the K difference values according to the preset statistical algorithm, to obtain a second statistical error, where a training object corresponding to each of the b difference values is used to execute a second task, the second task is one of N tasks, and is different from the first task, 0≤b≤K, 1≤a+b≤K, and b is an integer, and adjusting the t^{th} group of dedicated weight values according to a preset reverse propagation algorithm and the first statistical error, adjusting the q^{th} group of dedicated weight values in the i^{th} network layer according to the preset reverse propagation algorithm and the second statistical error, and adjusting a shared weight value according to the preset reverse propagation algorithm, the first statistical error, and the second statistical error, where the q^{th} group of dedicated weight values are dedicated weight values in the i^{th} network layer that uniquely correspond to the second task, N≥q≥1, q≠t, and q is an integer”, and re-obtaining training information, and performing the training processing operation based on the re-obtained training information and the neural network model obtained by adjusting the t^{th} group of dedicated weight values, the q^{th} group of dedicated weight values, and the shared weight value, until a difference value between a preset parameter of the neural network model obtained by performing the training processing operation for the x^{th} time and a preset parameter of the neural network model obtained by performing the training processing operation for the (x−y)^{th} time is less than a first preset threshold or until a quantity of times of performing the training processing operation reaches a second preset threshold, where x is an integer greater than or equal to 2, and y is a positive integer.

It is easy to understand that the training processing operation is adjusting a related weight value of the i^{th} network layer, and the training method is performing the training processing operation based on obtained training information and then re-obtaining training information and performing the training processing operation using the re-obtained training information and the neural network model obtained by adjusting a weight value. The training process is an iterative process. In actual application, training of the neural network model needs to be completed using a large quantity of training objects such that the neural network model is stable.

According to a fifth aspect, a processing apparatus is provided. The processing apparatus includes the neural network model according to any one of the first aspect and the possible implementations of the first aspect. Further, the processing apparatus includes an obtaining unit, a receiving unit, a processing unit, and a transmission unit.

Functions implemented by the unit modules provided in this application are as follows.

The obtaining unit is configured to obtain a first to-be-processed object. The receiving unit is configured to receive a first processing operation input by a user, where the first processing operation is used to instruct to execute a first task on the first to-be-processed object obtained by the obtaining unit. The processing unit is configured to, in response to the first processing operation received by the receiving unit, obtain the t^{th} group of dedicated weight values, a shared weight value, and first input data in the i^{th} network layer, and obtain first output data based on the t^{th} group of dedicated weight values, the shared weight value, and the first input data, where when 1<i≤M, the first input data is data output after the (i−1)^{th} network layer in M network layers processes the first to-be-processed object, or when i=1, the first input data is data of the first to-be-processed object. The transmission unit is configured to transmit the first output data obtained by the processing unit. The obtaining unit is further configured to obtain a second to-be-processed object. The receiving unit is further configured to receive a second processing operation input by the user, where the second processing operation is used to instruct to execute a second task on the second to-be-processed object obtained by the obtaining unit, the second task is one of N tasks, and the second task is different from the first task. The processing unit is further configured to in response to the second processing operation received by the receiving unit, obtain the q^{th} group of dedicated weight values and second input data in the i^{th} network layer, and obtain second output data based on the q^{th} group of dedicated weight values, the second input data, and the obtained shared weight value, where the q^{th} group of dedicated weight values are dedicated weight values in the i^{th} network layer that uniquely correspond to the second task, N≥q≥1, q≠t, and q is an integer, and when 1<i≤M, the second input data is data output after the (i−1)^{th} network layer processes the second to-be-processed object, or when i=1, the second input data is data of the second to-be-processed object. The transmission unit is further configured to transmit the second output data obtained by the processing unit.

According to a sixth aspect, a processing apparatus is provided. The processing apparatus includes the neural network model according to any one of the first aspect and the possible implementations of the first aspect. Further, the processing apparatus includes an obtaining unit, a receiving unit, a processing unit, and a transmission unit.

Functions implemented by the unit modules provided in this application are as follows.

The obtaining unit is configured to obtain a first to-be-processed image. The receiving unit is configured to receive a first processing operation input by a user, where the first processing operation is used to instruct to execute an image denoising task on the first to-be-processed image obtained by the obtaining unit. The processing unit is configured to, in response to the first processing operation received by the receiving unit, obtain the t^{th} group of dedicated weight values, a shared weight value, and first input data in the i^{th} network layer, and obtain first output data based on the t^{th} group of dedicated weight values, the shared weight value, and the first input data, where when 1<i≤M, the first input data is data output after the (i−1)^{th} network layer in M network layers processes the first to-be-processed image, or when i=1, the first input data is data of the first to-be-processed image. The transmission unit is configured to transmit the first output data obtained by the processing unit. The obtaining unit is further configured to obtain a second to-be-processed image. The receiving unit is further configured to receive a second processing operation input by the user, where the second processing operation is used to instruct to perform an image recognition task on the second to-be-processed image obtained by the obtaining unit, and the image recognition task is one of N tasks. The processing unit is further configured to in response to the second processing operation, obtain the q^{th} group of dedicated weight values and second input data in the i^{th} network layer, and obtain second output data based on the q^{th} group of dedicated weight values, the second input data, and the obtained shared weight value, where the q^{th} group of dedicated weight values are dedicated weight values in the i^{th} network layer that uniquely correspond to the image recognition task, N≥q≥1, q≠t, and q is an integer, and when 1<i≤M, the second input data is data output after the (i−1)^{th} network layer processes the second to-be-processed image, or when i=1, the second input data is data of the second to-be-processed image. The transmission unit is further configured to transmit the second output data obtained by the processing unit.

According to a seventh aspect, a processing apparatus is provided. The processing apparatus includes an obtaining unit and a processing unit.

Functions implemented by the unit modules provided in this application are as follows.

The obtaining unit is configured to obtain training information that includes K (K is a positive integer) training objects and marking information of each of the K training objects. The processing unit is configured to perform a training processing operation based on the training information obtained by the obtaining unit, where the training processing operation is “inputting the K training objects into a neural network model to obtain K processing results, where each of the K processing results uniquely corresponds to one training object, determining K difference values, where each of the K difference values represents a difference between each processing result and marking information of a training object corresponding to the processing result, performing calculation on a difference values in the K difference values according to a preset statistical algorithm, to obtain a first statistical error, where a training object corresponding to each of the a difference values is used to execute a first task, 0≤a≤K, and a is an integer, performing calculation on b difference values in the K difference values according to the preset statistical algorithm, to obtain a second statistical error, where a training object corresponding to each of the b difference values is used to execute a second task, the second task is one of N tasks, and is different from the first task, 0≤b≤K, 1≤a+b≤K, and b is an integer, and adjusting the t^{th} group of dedicated weight values according to a preset reverse propagation algorithm and the first statistical error, adjusting the q^{th} group of dedicated weight values in the i^{th} network layer according to the preset reverse propagation algorithm and the second statistical error, and adjusting a shared weight value according to the preset reverse propagation algorithm, the first statistical error, and the second statistical error, where the q^{th} group of dedicated weight values are dedicated weight values in the i^{th} network layer that uniquely correspond to the second task, N≥q≥1, q≠t, and q is an integer”. The obtaining unit is further configured to re-obtain training information. The processing unit is further configured to perform the training processing operation based on the training information re-obtained by the obtaining unit and the neural network model obtained by the processing unit by adjusting the t^{th} group of dedicated weight values, the q^{th} group of dedicated weight values, and the shared weight value, until a difference value between a preset parameter of the neural network model obtained by performing the training processing operation for the x^{th} time and a preset parameter of the neural network model obtained by performing the training processing operation for the (x−y)^{th} time is less than a first preset threshold or until a quantity of times of performing the training processing operation reaches a second preset threshold, where x is an integer greater than or equal to 2, and y is a positive integer.

According to an eighth aspect, a processing apparatus is provided. The processing apparatus includes one or more processors, a memory, and a communications interface. The memory, the communications interface, and the one or more processors are coupled. The processing apparatus communicates with another device through the communications interface. The memory is configured to store computer program code. The computer program code includes an instruction. When the one or more processors execute the instruction, the processing apparatus performs the data processing method according to the second aspect or the third aspect, or performs the method for training a neural network model according to the fourth aspect.

According to a ninth aspect, a computer readable storage medium is further provided. The computer readable storage medium stores an instruction. When the instruction runs on the processing apparatus according to the eighth aspect, the processing apparatus performs the data processing method according to the second aspect or the third aspect, or performs the method for training a neural network model according to the fourth aspect.

According to a tenth aspect, a computer program product including an instruction is further provided. When the instruction runs on the processing apparatus according to the eighth aspect, the processing apparatus performs the data processing method according to the second aspect or the third aspect, or performs the method for training a neural network model according to the fourth aspect.

For specific descriptions of the eighth aspect, the ninth aspect, the tenth aspect, and various implementations of the eighth aspect, the ninth aspect, and the tenth aspect, refer to the detailed descriptions of any one of the second aspect, the third aspect, and the fourth aspect. In addition, for beneficial effects of the eighth aspect, the ninth aspect, the tenth aspect, and various implementations of the eighth aspect, the ninth aspect, the tenth aspect, refer to the beneficial effect analysis of any one of the second aspect, the third aspect, and the fourth aspect. Details are not described herein again.

In this application, a name of the processing apparatus does not constitute a limitation on devices or function modules. In actual implementation, these devices or function modules may have other names. The devices or the function modules fall within the scopes of the claims of this application and equivalent technologies thereof provided that functions of the devices or the function modules are similar to those in this application.

These aspects and other aspects of this application are clearer and easier to understand in the following descriptions.

### BRIEF DESCRIPTION OF DRAWINGS

FIG. 1 is a schematic diagram of a mobile phone according to an embodiment of this application;

FIG. 2 is a schematic structural diagram of hardware of a mobile phone according to an embodiment of this application;

FIG. 3 is a schematic structural diagram 1 of a neural network model according to an embodiment of this application;

FIG. 4 is a schematic diagram 1 of a data processing procedure of the i^{th} network layer according to an embodiment of this application;

FIG. 5 is a schematic diagram 2 of a data processing procedure of the i^{th} network layer according to an embodiment of this application;

FIG. 6 is a schematic structural diagram 2 of a neural network model according to an embodiment of this application;

FIG. 7 is a schematic structural diagram 3 of a neural network model according to an embodiment of this application;

FIG. 8 is a schematic structural diagram 4 of a neural network model according to an embodiment of this application;

FIG. 9 is a schematic flowchart of processing an image by a neural network model according to an embodiment of this application;

FIGS. 10A, 10B, 10C, and 10D are schematic diagrams of images obtained through processing by different models according to an embodiment of this application;

FIG. 11 is a schematic structural diagram 1 of a processing apparatus according to an embodiment of this application; and

FIG. 12 is a schematic structural diagram 2 of a processing apparatus according to an embodiment of this application.

### DESCRIPTION OF EMBODIMENTS

In embodiments of this application, the word “exemplary” or “for example” is used to represent giving an example, an illustration, or a description. Any embodiment or design scheme described as an “exemplary” or “for example” in the embodiments of this application should not be explained as being more preferred or having more advantages than another embodiment or design scheme. Exactly, use of the word “exemplary” or “example” or the like is intended to present a relative concept in a specific manner.

The following terms “first” and “second” are merely intended for a purpose of description, and shall not be understood as an indication or implication of relative importance or implicit indication of the number of indicated technical features. Therefore, a feature limited by “first” or “second” may explicitly or implicitly include one or more features. In the description of the embodiment of this application, unless otherwise stated, “multiple” means two or more than two.

A deep neural network simulates a neural connection structure of a human brain by establishing a model. When signals such as an image, a sound, and a text are being processed, data features are described by layer through a plurality of transformation stages.

Generally, a neural network includes a plurality of network layers. Each network layer processes input data of the network layer, and transmits processed data to a next network layer. Further, in each network layer, a processing apparatus (a device that stores the neural network) performs processing such as convolution or multiply-add processing on input data using a weight value corresponding to the network layer. A processing manner of the processing apparatus depends on an attribute of a network layer (for example, a convolutional layer or a fully connected layer), and a weight value used by the processing apparatus is determined by the processing apparatus in a process of training the neural network. The processing apparatus adjusts a weight value corresponding to a network layer to obtain different data processing results.

A CNN model is one of deep neural network models. The CNN has made remarkable achievements in application fields such as image recognition, voice processing, and intelligent robots. A CNN model processing a plurality of tasks has a relatively strong generalization capability such that resources occupied by each task and storage costs can be appropriately reduced. In many image processing fields, for example, for an image enhancement task, a chip-based neural network accelerator in a terminal can execute only one image enhancement task in a specified time period and output a single image. Therefore, a CNN model that can serially execute a plurality of tasks is provided.

In other approaches, there is a feasible CNN model that can serially execute a plurality of tasks. Further, the plurality of tasks shares a weight value in at least one convolutional layer in the CNN model, and for a convolutional layer in which a weight value is shared (or a shared layer), all weight values of the shared layer are shared. Sharing a weight value in the CNN model can not only reduce a quantity of weight values, but also reduce a bandwidth requirement of a terminal during task switching. However, sharing all the weight values of the shared layer reduces effective utilization of image features in the shared layer when the terminal executes different tasks, and degrades performance of the CNN model when the CNN model processes different tasks.

To resolve the foregoing problem, an embodiment of this application provides a neural network model that is used to complete N (N is an integer greater than or equal to 2) tasks. The neural network model includes M (M is a positive integer) network layers, and the i^{th} (1≤i≤M, and i is an integer) network layer in the M network layers has a shared weight value and N groups of dedicated weight values. Herein, the shared weight value is used to execute each of the N tasks, and each of the N groups of dedicated weight values is used to execute one of the N tasks, and all the groups of dedicated weight values are in a one-to-one correspondence with the N tasks. When executing a first task in the N tasks, the i^{th} network layer is configured to obtain input data, obtain output data based on the t^{th} (1≤t≤N, and t is an integer) group of dedicated weight values, the shared weight value, and the obtained input data, and when 1≤i≤M, transmit the output data to the (i+1)^{th} network layer in the M network layers, where the t^{th} group of dedicated weight values corresponds to the first task, or when i=M, output the output data. It can be learned that, for any task, when performing data processing, the i^{th} network layer only needs to obtain the shared weight value and a dedicated weight value corresponding to a current task, without obtaining a dedicated weight value corresponding to another task such that performance of the i^{th} network layer is effectively improved, and performance of the neural network model is further improved.

In addition, the shared weight value is used to execute each of the N tasks. Therefore, in a scenario of task switching, the i^{th} network layer only needs to obtain a dedicated weight value corresponding to a current task, without re-obtaining the shared weight value such that a quantity of data read times is reduced, and processing performance is improved.

It should be noted that in this application, a structure of the “(i+1)^{th} network layer in the M network layers” and a structure of the “i^{th} network layer” may be the same (that is, each has the shared weight value and N groups of dedicated weight values), or may be different. In a scenario in which the structure of the “(i+1)^{th} network layer in the M network layers” and the structure of the i^{th} network layer” are different, the “(i+1)^{th} network layer in the M network layers” may have only the shared weight value (that is, without a dedicated weight value), or may not have the shared weight value (that is, with only a dedicated weight value). This is not limited in this application.

It is easy to understand that the network neural model in this application may include at least one network layer that has a same structure as the “i^{th} network layer”.

The neural network model provided in this application may be any artificial neural network model such as a CNN model. This is not limited in this embodiment of this application.

The neural network model provided in this embodiment of this application may be stored in a processing apparatus. The processing apparatus may be an electronic device.

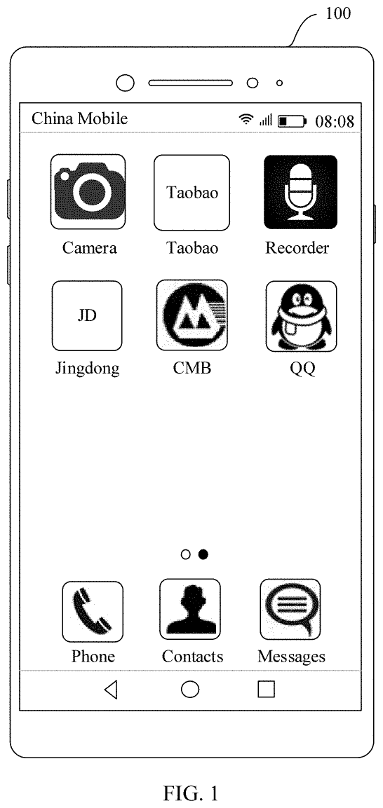

The electronic device may be a mobile phone (a mobile phone 100 shown in FIG. 1), a tablet computer, a personal computer (PC), a personal digital assistant (PDA), a smartwatch, a netbook, a wearable electronic device, or the like that allows a user to input a processing operation to instruct the electronic device to perform a related operation event. A specific form of the electronic device is not specially limited in this embodiment of this application.

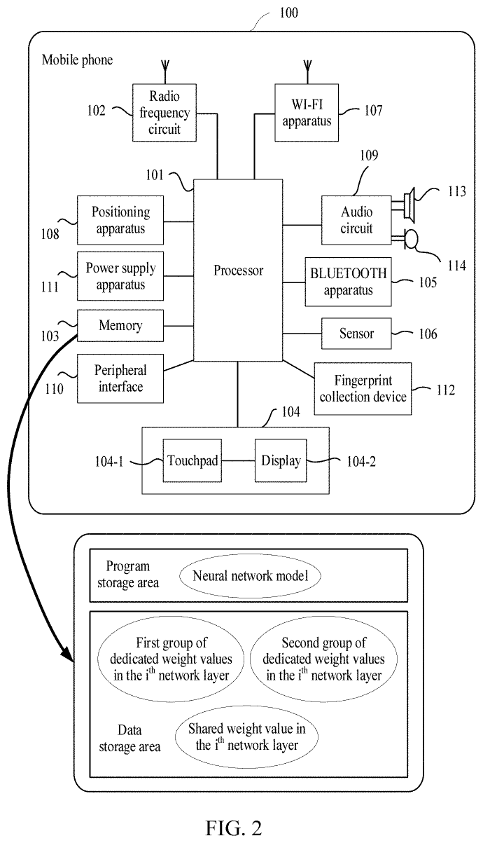

As shown in FIG. 2, the mobile phone 100 is used as an example of the electronic device. The mobile phone 100 may include components such as a processor 101, a radio frequency (RF) circuit 102, a memory 103, a touchscreen 104, a BLUETOOTH apparatus 105, one or more sensors 106, a Wi-Fi apparatus 107, a positioning apparatus 108, an audio circuit 109, a peripheral interface 110, and a power supply apparatus 111. These components may perform communication through one or more communications buses or signal cables (not shown in FIG. 2). A person skilled in the art may understand that a hardware structure shown in FIG. 2 does not constitute a limitation on the mobile phone, and the mobile phone 100 may include more or fewer components than those shown in the figure, or may combine some components, or have different component arrangements.

The following describes the components of the mobile phone 100 in detail with reference to FIG. 2.

As a control center of the mobile phone 100, the processor 101 is connected to all parts of the mobile phone 100 using various interfaces and lines, and performs various functions and data processing of the mobile phone 100 by running or executing an application program stored in the memory 103 and invoking data stored in the memory 103. In some embodiments, the processor 101 may include one or more processing units. In some of the embodiments of this application, the processor 101 may further include a fingerprint verification chip configured to perform verification on a collected fingerprint.

In this embodiment of this application, the processor 101 may invoke training information to implement training of a neural network model. Further, the processor 101 obtains training information that includes K (K is a positive integer) training objects and marking information of each of the K training objects, and performs a training processing operation based on the obtained training information, where the training processing operation is “inputting the K training objects into the neural network model to obtain K processing results, where each of the K processing results uniquely corresponds to one training object, determining K difference values, where each of the K difference values represents a difference between each processing result and marking information of a training object corresponding to the processing result, performing calculation on a difference values in the K difference values according to a preset statistical algorithm, to obtain a first statistical error, where a training object corresponding to each of the a difference values is used to execute a first task, 0≤a≤K, and a is an integer, performing calculation on b difference values in the K difference values according to the preset statistical algorithm, to obtain a second statistical error, where a training object corresponding to each of the b difference values is used to execute a second task, the second task is one of N tasks, and is different from the first task, 0≤b≤K, 1≤a+b≤K, and b is an integer, and adjusting the t^{th} group of dedicated weight values according to a preset reverse propagation algorithm and the first statistical error, adjusting the q^{th} group of dedicated weight values in the i^{th} network layer according to the preset reverse propagation algorithm and the second statistical error, and adjusting a shared weight value according to the preset reverse propagation algorithm, the first statistical error, and the second statistical error, where the q^{th} group of dedicated weight values are dedicated weight values in the i^{th} network layer that uniquely correspond to the second task, N≥q≥1, q≠t, and q is an integer”. Then the processor 101 re-obtains training information, and performs the training processing operation based on the re-obtained training information and the neural network model obtained by adjusting the t^{th} group of dedicated weight values, the q^{th} group of dedicated weight values, and the shared weight value, until a difference value between a preset parameter of the neural network model obtained by performing the training processing operation for the x^{th} time and a preset parameter of the neural network model obtained by performing the training processing operation for the (x−y)^{th} time is less than a first preset threshold or until a quantity of times of performing the training processing operation reaches a second preset threshold, where x is an integer greater than or equal to 2, and y is a positive integer.

In addition, the processor 101 may further process a to-be-processed object based on a neural network model. Further, after obtaining a first to-be-processed object and a first processing operation that is used to instruct to execute a first task on the first to-be-processed object and that is input by a user, the processor 101 processes the first to-be-processed object using the neural network model. Further, the processor 101 obtains the t^{th} group of dedicated weight values, a shared weight value, and first input data in the i^{th} network layer, obtains first output data based on the t^{th} group of dedicated weight values, the shared weight value, and the first input data, and then transmits the first output data. When 1<i≤M, the first input data is data output after the (i−1)^{th} network layer in M network layers processes the first to-be-processed object, or when i=1, the first input data is data of the first to-be-processed object. Then, after obtaining a second to-be-processed object and a second processing operation that is input by the user and that is used to instruct to perform a second task on the second to-be-processed object, the processor 101 processes the second to-be-processed object using the neural network model. Further, the processor 101 obtains the q^{th} (N≥q≥1, q≠t, and q is an integer) group of dedicated weight values, the shared weight value, and second input data in the i^{th} network layer, obtains second output data based on the q^{th} group of dedicated weight values, the shared weight value, and the second input data, and then transmits the second output data. When 1<i≤M, the second input data is data output after the (i−1)^{th} network layer in the M network layers processes the second to-be-processed object, or when i=1, the second input data is data of the second to-be-processed object.

The processor 101 may further periodically update the neural network model such that the neural network model better meets an actual requirement.

The radio frequency circuit 102 may be configured to receive and send a radio signal in an information receiving and sending process or in a call process. In particular, after receiving downlink data from a base station, the radio frequency circuit 102 may send the downlink data to the processor 101 for processing. In addition, the radio frequency circuit 102 sends uplink data to the base station. Generally, the radio frequency circuit includes but is not limited to an antenna, at least one amplifier, a transceiver, a coupler, a low noise amplifier, a duplexer, and the like. In addition, the radio frequency circuit 102 may further communicate with another device through wireless communication. The wireless communication may use any communication standard or protocol, including but not limited to a global system for mobile communications, a general packet radio service, code division multiple access, wideband code division multiple access, long term evolution, email, a short message service, and the like.

The memory 103 is configured to store an application program and data. The processor 101 performs various functions and data processing of the mobile phone 100 by running the application program and the data stored in the memory 103. The memory 103 mainly includes a program storage area and a data storage area. The program storage area may store an operating system, and an application program required by at least one function (for example, a sound play function or an image processing function). The data storage area may store data (for example, audio data or a phone book) created based on use of the mobile phone 100. In addition, the memory 103 may include a high-speed random-access memory (RAM), or may include a nonvolatile memory such as a magnetic disk storage device, a flash storage device, or another volatile solid-state storage device. The memory 103 may store various operating systems such as an iOS® operating system and an Android® operating system. The memory 103 may be independent, and is connected to the processor 101 through the communications bus. Alternatively, the memory 103 and the processor 101 may be integrated together.

In this embodiment of this application, the neural network model may be considered as an application program that can implement functions such as image processing, word processing, and voice processing in the program storage area. A weight value of each network layer in the neural network model is stored in the data storage area.

Weight values used by the neural network model in a running process are stored in the memory 103 in a multi-level storage manner. A weight value of each network layer in the neural network model is stored in an off-chip memory, namely, the foregoing nonvolatile memory. The i^{th} network layer is used as an example. When executing a current task, the processor 101 reads, from the nonvolatile memory, a weight value corresponding to the current task in the i^{th} network layer into a memory, and then the processor 101 reads, from the memory, a currently needed weight value into a cache.

It can be learned from the foregoing description that the network neural model in this application may include at least one network layer that has a same structure as the “i^{th} network layer”. For ease of description, a network layer with this structure is a target network layer in this embodiment of this application. Optionally, in this embodiment of this application, dedicated weight values of all tasks in a target network layer may be stored in different regions of the memory 103, and shared weight values of different target network layers may also be stored in different regions of the memory 103 such that when executing different tasks, the processor 101 can quickly read a weight value needed by the processor 101, thereby improving a speed of reading the weight value. For example, the first group of dedicated weight values, the second group of dedicated weight values, and a shared weight value in the i^{th} network layer in FIG. 2 are stored in different storage locations in the memory 103.

If the mobile phone 100 further includes another memory different from the memory 103, and the other memory has a same type as the memory 103, weight values of different target network layers may be stored in different memories of this type. This is not limited in this embodiment of this application.

The touchscreen 104 may include a touchpad 104-1 and a display 104-2.

The touchpad 104-1 may collect a touch event performed by a user of the mobile phone 100 on or near the touchpad 104-1 (for example, an operation performed by the user on the touchpad 104-1 or near the touchpad 104-1 using any proper object such as a finger or a stylus), and send collected touch information to another component (for example, the processor 101). The touch event performed by the user near the touchpad 104-1 may be a floating touch. The floating touch may mean that the user does not need to directly touch the touchpad for selecting, moving, or dragging a target (for example, an icon), and the user only needs to be near the device to perform a desired function. In addition, the touchpad 104-1 may be implemented in a plurality of types such as a resistive type, a capacitive type, an infrared type, or a surface acoustic wave type.

The display (or a display screen) 104-2 may be configured to display information entered by the user or information provided for the user, and various menus of the mobile phone 100. The display 104-2 may be configured in a form of a liquid crystal display, an organic light emitting diode, or the like. The touchpad 104-1 may cover the display 104-2. When detecting a touch event on or near the touchpad 104-1, the touchpad 104-1 transfers the touch event to the processor 101 to determine a type of the touch event. Then the processor 101 may provide corresponding visual output on the display 104-2 based on the type of the touch event. Although the touchpad 104-1 and the display screen 104-2 in FIG. 2 are used as two independent components to implement input and output functions of the mobile phone 100, in some embodiments, the touchpad 104-1 and the display screen 104-2 may be integrated to implement the input and output functions of the mobile phone 100. It may be understood that the touchscreen 104 is formed by stacking a plurality of layers of materials. In this embodiment of this application, only the touchpad (layer) and the display screen (layer) are displayed, and another layer is not described in this embodiment of this application. In addition, the touchpad 104-1 may be disposed on the front of the mobile phone 100 in a form of a full panel, and the display screen 104-2 may also be disposed on the front of the mobile phone 100 in the form of a full panel. In this way, a frame-less structure can be implemented on the front of the mobile phone.

In addition, the mobile phone 100 may further have a fingerprint recognition function. For example, a fingerprint collection device 112 may be disposed on the back of the mobile phone 100 (for example, below a rear-facing camera), or a fingerprint collection device 112 may be disposed on the front of the mobile phone 100 (for example, below the touchscreen 104). For another example, a fingerprint collection device 112 may be disposed on the touchscreen 104 to implement the fingerprint recognition function. That is, the fingerprint collection device 112 and the touchscreen 104 may be integrated to implement the fingerprint recognition function of the mobile phone 100. In this case, the fingerprint collection device 112 is disposed on the touchscreen 104, and may be a part of the touchscreen 104, or may be disposed on the touchscreen 104 in another manner. A main component of the fingerprint collection device 112 in this embodiment of this application is a fingerprint sensor. The fingerprint sensor may use any type of sensing technology, including but not limited to an optical sensing technology, a capacitive sensing technology, a piezoelectric sensing technology, an ultrasonic sensing technology, and the like.

The mobile phone 100 may further include the BLUETOOTH apparatus 105 configured to exchange short-range data between the mobile phone 100 and another device (for example, a mobile phone or a smartwatch). The BLUETOOTH apparatus in this embodiment of this application may be an integrated circuit, a BLUETOOTH chip, or the like.

The mobile phone 100 may further include at least one sensor 106 such as a light sensor, a motion sensor, and other sensors. Further, the light sensor may include an ambient light sensor and a proximity sensor. The ambient light sensor may adjust luminance of the display of the touchscreen 104 based on brightness of ambient light, and the proximity sensor may turn off a power supply of the display when the mobile phone 100 moves to an ear. As a type of motion sensor, an accelerometer sensor may detect an acceleration value in each direction (generally three axes), may detect a value and a direction of gravity when the mobile phone 100 is stationary, and may be applied to an application for recognizing a mobile phone posture (for example, switching between landscape and portrait screens, a related game, and magnetometer posture calibration), a function related to vibration recognition (for example, a pedometer or a knock), and the like. Other sensors such as a gyroscope, a barometer, a hygrometer, a thermometer, and an infrared sensor that may also be disposed on the mobile phone 100 are not described herein.

The Wi-Fi apparatus 107 is configured to provide, for the mobile phone 100, network access that complies with a Wi-Fi related standard protocol. The mobile phone 100 may access a Wi-Fi access point using the Wi-Fi apparatus 107, to help the user receive and send an email, browse a web page, access streaming media, and the like. The Wi-Fi apparatus 107 provides wireless broadband Internet access for the user. In some other embodiments, the Wi-Fi apparatus 107 may also be used as a Wi-Fi wireless access point, and may provide Wi-Fi network access for another device.

The positioning apparatus 108 is configured to provide a geographic location for the mobile phone 100. It may be understood that the positioning apparatus 108 may be further a receiver of a positioning system such as a Global Positioning System (GPS), a BEIDOU navigation satellite system, or a Russian GLONASS. After receiving the geographic location sent by the positioning system, the positioning apparatus 108 sends the information to the processor 101 for processing, or sends the information to the memory 103 for storage. In some other embodiments, the positioning apparatus 108 may be alternatively a receiver of an Assisted GPS (AGPS). The AGPS system serves as an assisted server to assist the positioning apparatus 108 in completing ranging and positioning services. In this case, the assisted positioning server communicates with the positioning apparatus 108 (namely, the GPS receiver) of the device such as the mobile phone 100 through a wireless communications network, and provides positioning assistance. In some other embodiments, the positioning apparatus 108 may be alternatively a positioning technology based on a Wi-Fi access point. Each Wi-Fi access point has a globally unique media access control (MAC) address, and the device can scan and collect a broadcast signal of a surrounding Wi-Fi access point when Wi-Fi is enabled. Therefore, the device can obtain a MAC address broadcast by the Wi-Fi access point. The device sends, using the wireless communications network, such data (for example, the MAC address) that can identify the Wi-Fi access point to a location server. The location server retrieves a geographical location of each Wi-Fi access point, calculates a geographical location of the device with reference to strength of the Wi-Fi broadcast signal, and sends the geographical location of the device to the positioning apparatus 108 of the device.

The audio circuit 109, a speaker 113, and a microphone 114 may provide an audio interface between the user and the mobile phone 100. The audio circuit 109 may transmit an electrical signal converted from received audio data to the speaker 113. The speaker 113 converts the electrical signal into a sound signal for output. In addition, the microphone 114 converts a collected sound signal into an electrical signal, the audio circuit 109 receives the electrical signal, converts the electrical signal into audio data, and then outputs the audio data to the RF circuit 102 for sending to another mobile phone, for example, or outputs the audio data to the memory 103 for further processing.

The peripheral interface 110 is configured to provide various interfaces for an external input/output device (for example, a keyboard, a mouse, an external display, an external memory, or a subscriber identity module card). For example, the mobile phone is connected to the mouse using a Universal Serial Bus (USB) interface, and is connected, using a metal contact on a card slot of the subscriber identity module card, to the subscriber identity module (SIM) card provided by a telecommunications operator. The peripheral interface 110 may be configured to couple the external input/output peripheral device to the processor 101 and the memory 103.

In this embodiment of this application, the mobile phone 100 may communicate with another device in a device group using the peripheral interface 110. For example, the mobile phone 100 may receive, using the peripheral interface 110 for display, display data sent by another device. This is not limited in this embodiment of this application.

The mobile phone 100 may further include the power supply apparatus 111 (for example, a battery or a power supply management chip) that supplies power to the components. The battery may be logically connected to the processor 101 using the power supply management chip such that functions such as charging management, discharging management, and power consumption management are implemented using the power supply apparatus 111.

Although not shown in FIG. 2, the mobile phone 100 may further include a camera (a front-facing camera and/or a rear-facing camera), a flash, a micro projection apparatus, a Near-Field-Communication (NFC) apparatus, and the like. Details are not described herein.

The following describes in detail a neural network model, a method for training a neural network model, and a data processing method that are provided in this application.

An embodiment of this application provides a neural network model 200. The neural network model 200 is an artificial neural network model, and can complete N (N≥2, and N is an integer) tasks.

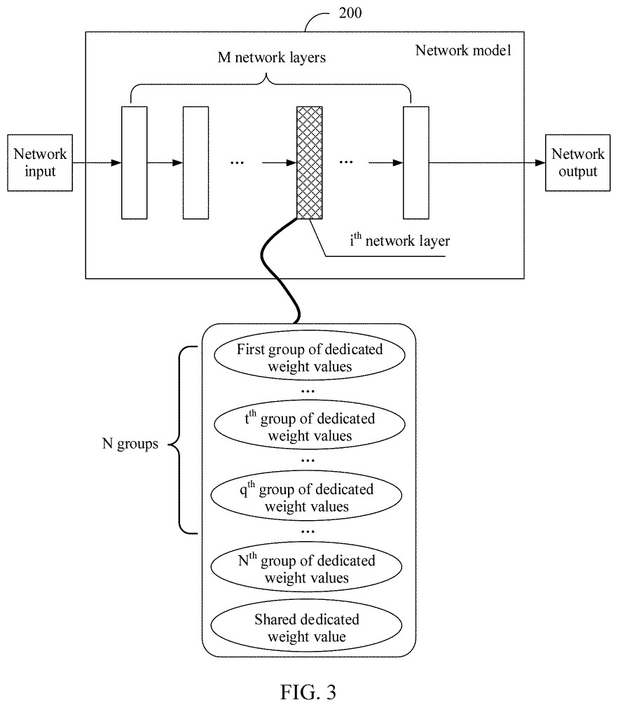

FIG. 3 is a schematic structural diagram of the neural network model 200. As shown in FIG. 3, the neural network model 200 includes M (M is a positive integer) network layers, and the i^{th} (1≤i≤M, and i is an integer) network layer in the M network layers has a shared weight value and N groups of dedicated weight values. The shared weight value is used to execute each of the N tasks, that is, a processing apparatus uses the shared weight value when executing any one of the N tasks in the i^{th} network layer. Each of the N groups of dedicated weight values is used to execute one of the N tasks, and all the groups of dedicated weight values are in a one-to-one correspondence with the N tasks.

The N groups of dedicated weight values in FIG. 3 include a first group of dedicated weight values, . . . , the t^{th} (1≤t≤N, and t is an integer) group of dedicated weight values, . . . , the q^{th} (1≤q≤N, q≠t, and q is an integer) group of dedicated weight values, . . . , and the N^{th} group of dedicated weight values. Each group of dedicated weight values uniquely corresponds to one task. For example, the t^{th} group of dedicated weight values in FIG. 3 uniquely corresponds to a first task in the N tasks, and the q^{th} group of dedicated weight values uniquely corresponds to a second task in the N tasks.

When executing the first task in the N tasks, the i^{th} network layer is configured to obtain input data, and obtain output data based on the t^{th} group of dedicated weight values, the shared weight value, and the input data. In this case, when 1≤i<M, the output data is transmitted to the (i+1)^{th} network layer in the M network layers, or when i=M, the output data is output.

It is easy to understand that when executing the first task, the i^{th} network layer only needs to perform calculation on the input data using the shared weight value and the t^{th} group of dedicated weight values, which is unrelated to another dedicated weight value. When the i^{th} network layer is the last layer in the neural network model 200, the output data obtained in the i^{th} network layer is output data of the neural network model 200. Therefore, the output data obtained in the i^{th} network layer is directly output. When the i^{th} network layer is not the last layer in the neural network model 200, the output data obtained in the i^{th} network layer needs to be transmitted to the (i+1)^{th} network layer such that the (i+1)^{th} network layer processes the output data.

In this embodiment of this application, the i^{th} network layer may be a convolutional layer, a fully connected layer, a deconvolution layer, or a recurrent layer, and this is not further limited in this embodiment of this application.

When the i^{th} network layer is a convolutional layer, the “obtaining output data based on the t^{th} group of dedicated weight values, the shared weight value, and the input data” is performed using the following method. Convolution calculation is performed on the input data using the shared weight value to obtain shared output data, and convolution calculation is performed on the input data using the t^{th} group of dedicated weight values to obtain dedicated output data. In this scenario, the output data includes the shared output data and the dedicated output data.

In this scenario, both the input data and the output data are three-dimensional tensors, and the shared weight value and the N groups of dedicated weight values are four-dimensional tensors. Herein, dimensions corresponding to the three-dimensional tensor are a length and a width of a feature map (or feature maps) and a quantity of feature maps, and dimensions corresponding to the four-dimensional tensor are a length and a width of a convolution kernel, a quantity of input feature maps, and a quantity of output feature maps.

When the i^{th} network layer is a fully connected layer, the “obtaining output data based on the t^{th} group of dedicated weight values, the shared weight value, and the input data” is performed using the following method Multiply-add calculation is performed on the input data using the shared weight value to obtain shared output data, and multiply-add calculation is performed on the input data using the t^{th} group of dedicated weight values to obtain dedicated output data. Similarly, in this scenario, the output data also includes the shared output data and the dedicated output data.

In this scenario, the output data is a one-dimensional vector, and the input data depends on a structure of a previous network layer of the fully connected layer.

If the previous network layer of the fully connected layer is a fully connected layer, output data of the previous network layer is a one-dimensional vector, and the input data of the fully connected layer is a one-dimensional vector. The dedicated weight value and the shared weight value of the fully connected layer may be two-dimensional matrices, and dimensions corresponding to the two-dimensional matrix are a quantity of input neurons and a quantity of output neurons.

If the previous network layer of the fully connected layer is a convolutional layer or a deconvolution layer, output data of the previous network layer is a feature map, and the input data of the fully connected layer is also a feature map, that is, the input data of the fully connected layer is a three-dimensional tensor. In this case, the dedicated weight value and the shared weight value of the fully connected layer may be four-dimensional tensors, and four dimensions of the four-dimensional tensor respectively correspond to a length and a width of an input feature map, a quantity of input feature maps, and a quantity of output neurons.

When the i^{th} network layer is a deconvolution layer, the “obtaining output data based on the t^{th} group of dedicated weight values, the shared weight value, and the input data” is performed using the following method. Transposed convolution calculation is performed on the input data using the shared weight value to obtain shared output data, and transposed convolution calculation is performed on the input data using the t^{th} group of dedicated weight values to obtain dedicated output data. Similarly, in this scenario, the output data also includes the shared output data and the dedicated output data.

In this scenario, both the input data and the output data are three-dimensional tensors, and the shared weight value and the N groups of dedicated weight values are four-dimensional tensors. Herein, dimensions corresponding to the three-dimensional tensor are a length and a width of a feature map (or feature maps) and a quantity of feature maps, and dimensions corresponding to the four-dimensional tensor are a length and a width of a convolution kernel, a quantity of input feature maps, and a quantity of output feature maps.

Generally, there are a plurality of structural forms of recurrent layers, for example, a recurrent neural network (RNN) and a long short-term memory (LSTM). The recurrent layer has a plurality of weight value matrices. When the i^{th} network layer is a recurrent layer, each weight value matrix or each of some weight value matrices includes the shared weight value and the N groups of dedicated weight values. For a weight value matrix, after target input data is obtained, multiply-add calculation is performed on the input data using the weight value matrix or an activation function to obtain target output data. Then multiply-add calculation is performed on the target output data using a next weight value matrix of the weight value matrix. It is easy to understand that if the weight value matrix is the first weight value matrix, the target input data is the input data. If the weight value matrix is not the first weight value matrix, the target input data is output data obtained through processing by a previous weight value matrix.

In this scenario, both the input data and the output data are one-dimensional vectors, and the shared weight value and the N groups of dedicated weight values are two-dimensional matrices.

It should be noted that a dimension and a quantity of pieces of input data and output data of each network layer in the neural network model need to be determined based on an actual requirement, and this is not limited in this embodiment of this application.

For ease of understanding, an example in which N=2 and the neural network model can complete the first task and the second task is currently used for description. The i^{th} network layer has the shared weight value that is used to execute the first task and the second task, the first group of dedicated weights uniquely corresponds to the first task, and the second group of dedicated weight values corresponds to the second task.

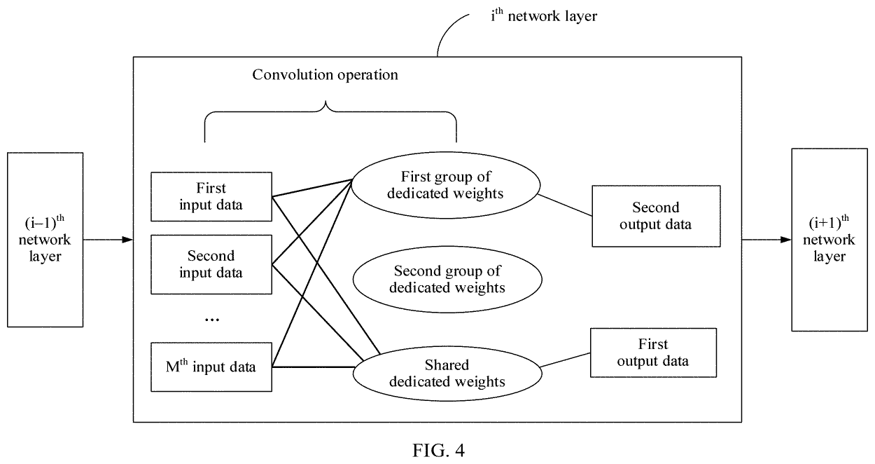

As shown in FIG. 4, if the i^{th} network layer is a convolutional layer, and a current task is the first task, after obtaining input data (first input data, second input data, . . . , and m^{th} input data) of the i^{th} network layer, the processing apparatus performs a convolution operation on the input data using the shared weight value to obtain first output data, and performs convolution calculation on the input data using the first group of dedicated weight values to obtain second output data. After obtaining the first output data and the second output data, the processing apparatus transmits the first output data and the second output data to the (i+1)^{th} network layer.

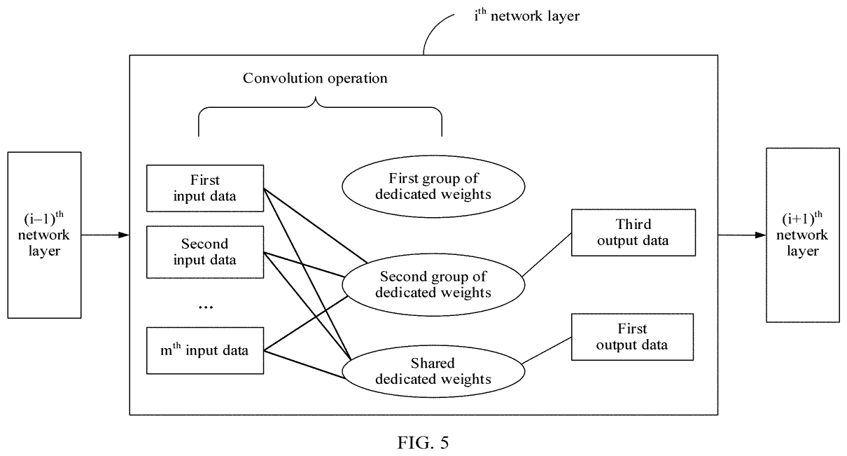

With reference to FIG. 4, as shown in FIG. 5, if the i^{th} network layer is a convolutional layer, and a current task is the second task, after obtaining input data (first input data, second input data, . . . , and m^{th} input data) of the i^{th} network layer, the processing apparatus performs a convolution operation on the input data using the shared weight value to obtain first output data, and performs convolution calculation on the input data using the second group of dedicated weight values to obtain third output data. After obtaining the first output data and the third output data, the processing apparatus transmits the first output data and the third output data to the (i+1)^{th} network layer.

It can be learned from the neural network model shown in FIG. 3 to FIG. 5 that when executing any task, the i^{th} network layer in the neural network model only needs to perform calculation on input data of the i^{th} network layer based on a dedicated weight value corresponding to the task and the shared weight value, without obtaining a dedicated weight value corresponding to another task such that performance of each target network layer is effectively improved, and performance of the neural network model is further improved.

It should be noted that in the neural network model 200 shown in FIG. 3, in addition to the i^{th} network layer, there may be h (h≥0) network layers that have a same structure as the i^{th} network layer.

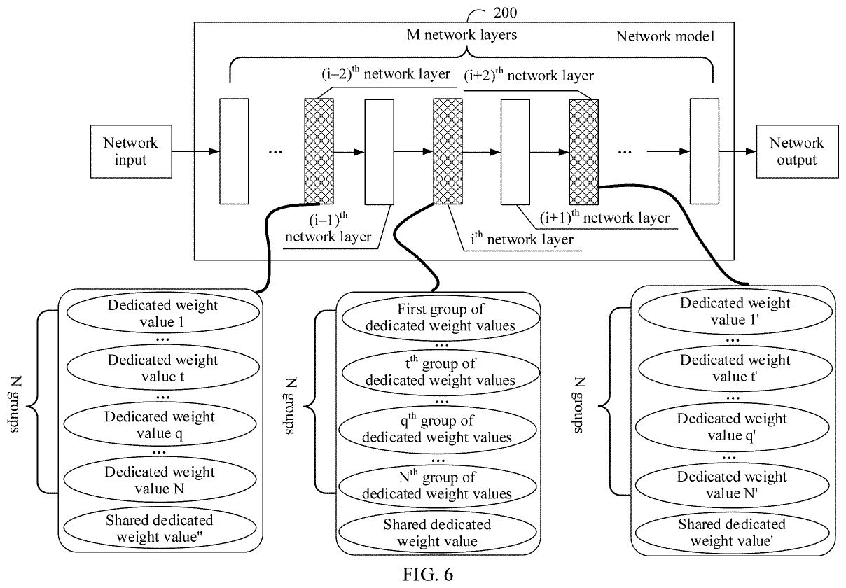

For example, with reference to FIG. 3, as shown in FIG. 6, in addition to the i^{th} network layer, each of the (i−2)^{th} network layer and the (i+2)^{th} network layer in the neural network model 200 also has a respective shared weight value and respective N groups of dedicated weight values, the (i−1)^{th} network layer has only a shared weight value, and the (i+1)^{th} network layer has only N groups of dedicated weight values. In this case, when executing any one of the N tasks in the (i−2)^{th} network layer, the processing apparatus uses the shared weight value of the (i−2)^{th} network layer. When the processing apparatus executes the first task in the (i−2)^{th} network layer, the processing apparatus uses a dedicated weight value that is in the (i−2)^{th} network layer and that uniquely corresponds to the first task. Similarly, when executing any one of the N tasks in the (i+2)^{th} network layer, the processing apparatus uses the shared weight value of the (i+2)^{th} network layer. When the processing apparatus executes the first task in the (i+2)^{th} network layer, the processing apparatus uses a dedicated weight value that is in the (i+2)^{th} network layer and that uniquely corresponds to the first task.

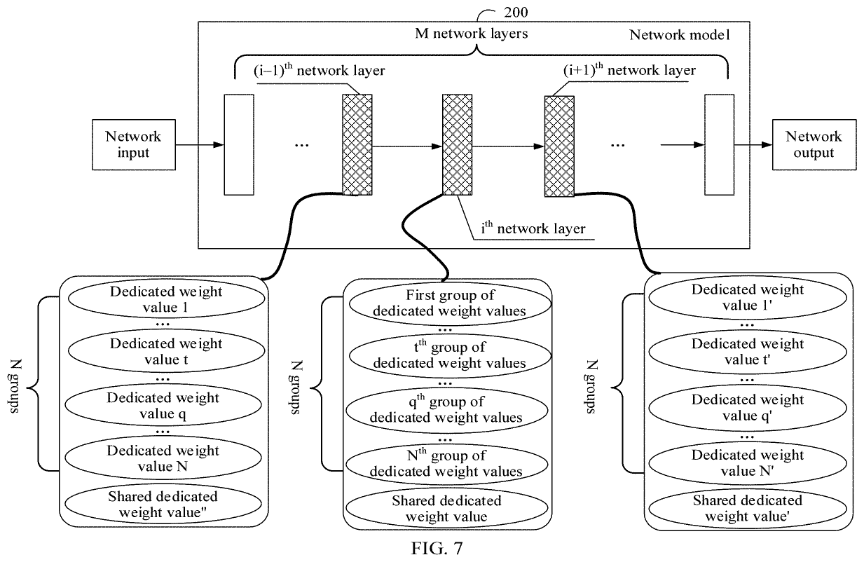

With reference to FIG. 3, as shown in FIG. 7, in addition to the i^{th} network layer, each of the (i−1)^{th} network layer and the (i+1)^{th} network layer in the neural network model 200 also has a respective shared weight value and respective N groups of dedicated weight values, and none of other network layers has such a structure. In this case, when executing any one of the N tasks in the (i−1)^{th} network layer, the processing apparatus uses the shared weight value of the (i−1)^{th} network layer. When the processing apparatus executes the first task in the (i−1)^{th} network layer, the processing apparatus uses a dedicated weight value that is in the (i−1)^{th} network layer and that uniquely corresponds to the first task. Similarly, when executing any one of the N tasks in the (i+1)^{th} network layer, the processing apparatus uses the shared weight value of the (i+1)^{th} network layer. When the processing apparatus executes the first task in the (i+1)^{th} network layer, the processing apparatus uses a dedicated weight value that is in the (i+1)^{th} network layer and that uniquely corresponds to the first task.

The structures of the neural network model 200 shown in FIG. 6 and FIG. 7 are merely examples of the neural network model 200, and do not constitute a limitation on the neural network model 200.

The neural network model provided in this application is applied to technical fields such as image processing and audio processing. For example, in the field of image processing technologies, the neural network model may complete tasks such as image denoising, to-be-processed image classification, and image recognition. In the field of audio processing technologies, the neural network model can complete tasks such as voice recognition.

In actual application, the processing apparatus needs to perform model training using a training object, to generate the neural network model.

A method for training a neural network model in this application is as follows. A processing apparatus obtains training information that includes K (K is a positive integer) training objects and marking information of each of the K training objects, and performs a training processing operation based on the obtained training information, where the training processing operation is “inputting the K training objects into a neural network model to obtain K processing results, where each of the K processing results uniquely corresponds to one training object, determining K difference values, where each of the K difference values represents a difference between each processing result and marking information of a training object corresponding to the processing result, performing calculation on a (0≤a≤K, and a is an integer) difference values in the K difference values according to a preset statistical algorithm (for example, weighted averaging), to obtain a first statistical error, where a training object corresponding to each of the a difference values is used to execute a first task, performing calculation on b (0≤b≤K, 1≤a+b≤K, and b is an integer) difference values in the K difference values according to the preset statistical algorithm, to obtain a second statistical error, where a training object corresponding to each of the b difference values is used to execute a second task, and adjusting the t^{th} group of dedicated weight values according to a preset reverse propagation algorithm and the first statistical error, adjusting the q^{th} group of dedicated weight values in the i^{th} network layer according to the preset reverse propagation algorithm and the second statistical error, and adjusting a shared weight value according to the preset reverse propagation algorithm, the first statistical error, and the second statistical error”. After adjusting the weight values, the processing apparatus re-obtains training information, and performs the training processing operation based on the re-obtained training information and the neural network model obtained by adjusting the t^{th} group of dedicated weight values, the q^{th} group of dedicated weight values, and the shared weight value, until a difference value between a preset parameter of the neural network model obtained by performing the training processing operation for the x^{th} (x is an integer greater than or equal to 2) time and a preset parameter of the neural network model obtained by performing the training processing operation for the (x−y)^{th} (y is a positive integer) time is less than a first preset threshold or until a quantity of times of performing the training processing operation reaches a second preset threshold.

It can be learned that the process of training the neural network model by the processing apparatus is an iterative process. In actual application, the processing apparatus needs to complete training using a large quantity of training objects such that the neural network model is stable.

In the training process, if all the K training objects obtained by the processing apparatus are used to complete the first task, the processing apparatus obtains the shared weight value, the t^{th} group of dedicated weight values, and input data in the i^{th} network layer, performs calculation on the input data using the shared weight value to obtain shared output data, and performs calculation on the input data using the t^{th} group of dedicated weight values to obtain dedicated output data. Then the processing apparatus transmits the shared output data and the dedicated output data to the (i+1)^{th} network layer.

Optionally, in the training process, if some of the K training objects obtained by the processing apparatus are used to complete the first task, the other training objects are used to complete the second task, and a current task is the first task, the processing apparatus obtains the shared weight value, the t^{th} group of dedicated weight values, the q^{th} group of dedicated weight values, and first input data in the i^{th} network layer, where the first input data is data of the training object used to execute the first task. Then the processing apparatus performs calculation on the first input data using the shared weight value to obtain shared output data, performs calculation on the first input data using the t^{th} group of dedicated weight values to obtain dedicated output data 1, and performs calculation on the first input data using the q^{th} group of dedicated weight values to obtain dedicated output data 2. Then, because the current task is the first task, the processing apparatus selects the shared output data and the dedicated output data 1 from the shared output data, the dedicated output data 1, and the dedicated output data 2 using a filter.

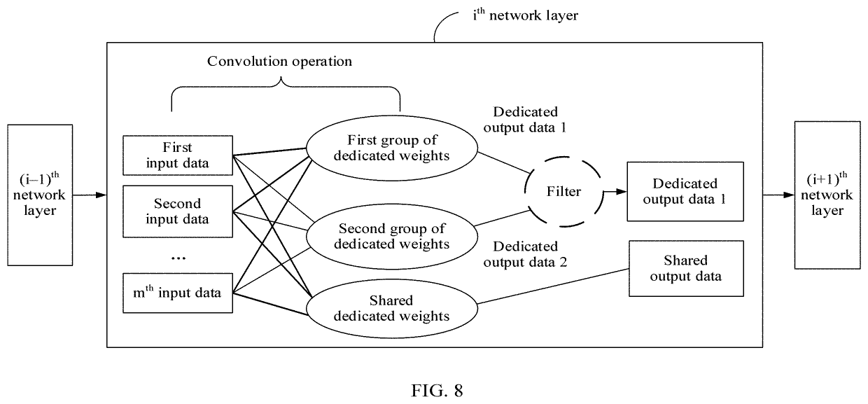

For example, with reference to FIG. 4 or FIG. 5, as shown in FIG. 8, the neural network model is used to execute the first task and the second task, the i^{th} network layer has the shared weight value that is used to execute the first task and the second task, the first group of dedicated weights uniquely corresponds to the first task, and the second group of dedicated weight values corresponds to the second task, a current task is the first task, and the i^{th} network layer is a convolutional layer. After obtaining input data (first input data, second input data, . . . , and m^{th} input data) of the i^{th} network layer, the processing apparatus performs a convolution operation on the obtained input data using the shared weight value to obtain shared output data, performs convolution calculation on the obtained input data using the first group of dedicated weight values to obtain dedicated output data 1, and performs convolution calculation on the obtained input data using the second group of dedicated weight values to obtain dedicated output data 2. Then, because the current task is the first task, the processing apparatus obtains only the shared output data and the dedicated output data 1 using the filter, and transmits the shared output data and the dedicated output data 1 to the (i+1)^{th} network layer.

It can be learned from the foregoing description that the filter in the training process is optional. Therefore, in FIG. 8, a dashed line is used to represent the filter.

It can be learned from the foregoing description that any network layer other than the i^{th} network layer in the neural network model may have only a shared weight value, may have only a dedicated weight value, or may have a shared weight value and N groups of dedicated weight values. Therefore, in a process of adjusting a task, the processing apparatus also needs to adjust a weight value corresponding to the task in the network layer.

Further, verification is performed on reliability of the neural network model provided in this application.

Herein, a seven-layer CNN model is used to execute an image denoising task. The seven-layer CNN model separately uses a structure of the neural network model provided in this application (the i^{th} convolutional layer in the CNN model has a shared weight value and a plurality of groups of dedicated weight values, and all the groups of dedicated weight values are in a one-to-one correspondence with tasks), an existing solution 1 (each convolutional layer in the CNN model has only a dedicated weight value but does not have a shared weight value), and an existing solution 2 (each of some convolutional layers in the CNN model has only a shared weight value but does not have a dedicated weight value, and each of the other convolutional layers has only a dedicated weight value but does not have a shared weight value) to perform denoising processing on an image such that reliability of the network model provided in this application is verified.

The first convolutional layer in the seven-layer CNN model is represented by conv1 (1, 5, 24), where conv1 (1, 5, 24) indicates that input of the first convolutional layer is one feature map, and output is 24 feature maps, and dimensions of a convolution kernel are 5×5. The second convolutional layer is represented by conv2 (24, 1, 6), where conv2 (24, 1, 6) indicates that input of the first convolutional layer is 24 feature maps, output is six feature maps, and dimensions of a convolution kernel are 1×1. The third convolutional layer is represented by conv3 (6, 3, 6), where conv3 (6, 3, 6) indicates that input of the third convolutional layer is six feature maps, output is six feature maps, and dimensions of a convolution kernel are 3×3. The fourth convolutional layer is represented by conv4 (6, 1, 6), where conv4 (6, 1, 6) indicates that input of the fourth convolutional layer is six feature maps, output is six feature maps, and dimensions of a convolution kernel are 1×1. The fifth convolutional layer is represented by conv5 (6, 3, 6), where conv5 (6, 3, 6) indicates that input of the fifth convolutional layer is six feature maps, output is six feature maps, and dimensions of a convolution kernel are 3×3. The sixth convolutional layer is represented by conv6 (6, 1, 16), where conv6 (6, 1, 16) indicates that input of the sixth convolutional layer is six feature maps, and output is 16 feature maps, and dimensions of the convolution kernel are 1×1. The seventh convolutional layer is represented by conv7 (16, 3, 1), where conv7 (16, 3, 1) indicates that input of the seventh convolutional layer is 16 feature maps, output is one feature map, and dimensions of a convolution kernel are 3×3.

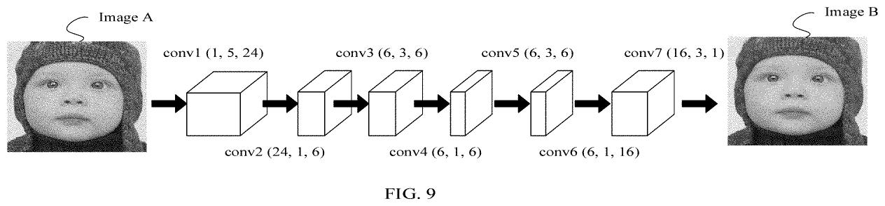

FIG. 9 shows a process of processing an image A using the foregoing seven-layer CNN model. After processing the image A, the seven-layer CNN model outputs an image B. It can be learned that definition of the image B is higher than that of the image A such that denoising of the image A is effectively implemented. A block in FIG. 9 represents a data flow, namely, a feature map, in a processing process of the CNN model. A width of the block represents a quantity of feature maps. A wider block indicates a larger quantity of feature maps. In an actual embodiment, tanh may be used as an activation function in the CNN model, where the activation function is not shown in FIG. 9.

Different levels of noise are added to a noise-free image in an original training database to generate a noisy image, where the noisy image is used to simulate an image obtained through photographing in a real scenario. In the real photographing scenario, in the case of different lighting, different photosensitive coefficients are used, and noise intensity in an image is different. Adding different levels of noise can simulate images photographed in different real scenarios and can also obtain, through training, a plurality of models for denoising for different levels of noise. That is, a noisy image is used as a training object, and an original noise-free image is used as marking information of the training object.

For example, noise whose variances (var) are 10, 30, and 50 is added to an original noise-free image, to generate noisy images. The original noise-free image may be an image in a BSD database. The seven-layer CNN model executes a denoising task for the three types of noisy images, that is, the seven-layer CNN model is used to complete three tasks.

Generally, a quantity of weight values in a convolutional layer is calculated according to the following formula:

Quantity of weight values in the convolutional layer=(Quantity of input feature maps×Width of a convolution kernel×Height of the convolution kernel+1)×Quantity of output feature maps.

Correspondingly, a quantity of weight values in the first convolutional layer in the seven-layer CNN model shown in FIG. 9 is 624, a quantity of weight values in the second convolutional layer is 150, a quantity of weight values in the third convolutional layer is 330, a quantity of weight values in the fourth convolutional layer is 42, a quantity of weight values in the fifth convolutional layer is 330, a quantity of weight values in the sixth convolutional layer is 112, and a quantity of weight values in the seventh convolutional layer is 145.

If the seven-layer CNN model shown in FIG. 9 is implemented using the existing solution 1, that is, each convolutional layer in the CNN model has only a dedicated weight value but does not have a shared weight value, for each task, a total quantity of weight values in the CNN model is 1733. Correspondingly, for the three tasks, a total quantity of weight values in the CNN model is 1733×3=5199.

If the seven-layer CNN model shown in FIG. 9 is implemented using the existing solution 2, each of the first four convolutional layers (the first convolutional layer to the fourth convolutional layer) in the CNN model has only a shared weight value but does not have a dedicated weight value, and each of the last three convolutional layers (the fifth convolutional layer to the seventh convolutional layer) has only a dedicated weight value but does not have a shared weight value. In this case, a quantity of weight values in the first four layers is 1146, and a quantity of weight values in the last three layers is 1761 (587×3=1761). A total quantity of weight values in the CNN model is 2907 (1146+1761=2907), and a proportion of shared weight values in the CNN is 1146/(1146+587)=66.1%.

If the seven-layer CNN model shown in FIG. 9 is implemented using this application, in each of the first convolutional layer, the third convolutional layer, and the fifth convolutional layer in the CNN model, ⅔ weight values are shared weight values and ⅓ weight values are dedicated weight values, each of the second convolutional layer, the fourth convolutional layer, and the sixth convolutional layer has only a shared weight value, and the seventh convolutional layer has only a dedicated weight value. In this case, a total quantity of weight values in the CNN model is 2879, where (624+330+330)×(⅔)+(624+330+330)×(⅓)×3+(150+42+112)+145×3=2879, and a proportion of shared weight values in the CNN model is 66.9%.

Table 1 shows peak signal to noise ratios (PSNR), a total quantity of weight values, and a proportion of shared weight values that are obtained after the seven-layer CNN model for completing the three tasks that is implemented using the existing solution 1, the existing solution 2, and this application performs denoising processing on an image.

TABLE 1

| | Total quantity of | Proportion | | | |
|---|---|---|---|---|---|
| | model weight values | of shared | | | |
| | of the three tasks | weight values | PSNR | | |
| | | | Var = 10 | Var = 30 | Var = 50 |
| Existing solution 1 | 5199 | 0% | 33.63 | 28.13 | 25.93 |
| Existing solution 2 | 2907 | 66.1% | 33.07 | 28.13 | 25.76 |
| This application | 2879 | 66.9% | 33.48 | 28.14 | 25.93 |

It can be learned from Table 1 that in comparison with the existing solution 1, the total quantity of weight values is reduced by 44.6% in the seven-layer CNN model for completing the three tasks that is implemented using this application, where (5199−2879)/5199=44.6%. The proportion of shared weight values is 66.9% in the seven-layer CNN model for completing the three tasks that is implemented using this application. In this way, during switching between different tasks, reading of weight values by a processing apparatus is reduced by 66.9%.

For handling relatively high noise, a denoising effect in this application is basically the same as that in the existing solution 1. For example, when Var=50, the peak signal-to noise ratio (PSNR) in this application is 25.93, and the PSNR in the existing solution is 25.93. For handling relatively low noise, a denoising effect in this application differs little from that in the existing solution 1. For example, when Var=10, the PSNR in this application is 33.48, the PSNR in the existing solution is 33.63, and a difference between the two is only 0.15. In addition, in a scenario in which proportions of shared weight values are similar in the existing solution 2 and this application, image processing quality is relatively high in this application.

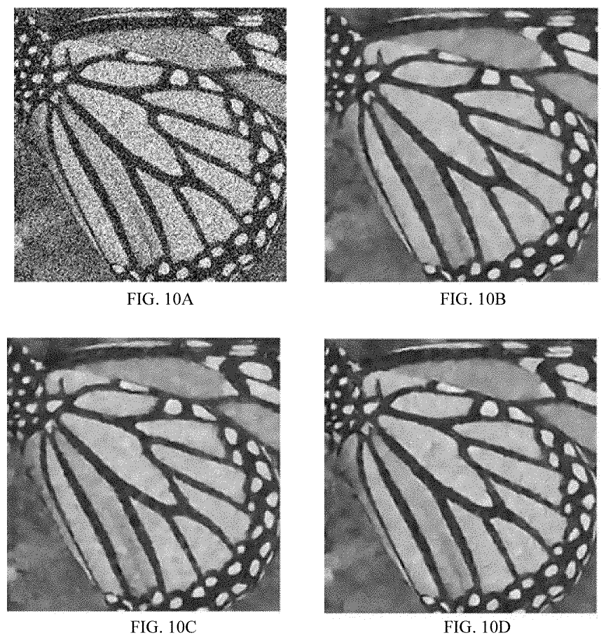

Table 1 describes, from the perspective of numbers, differences in image processing using the existing solution 1, the existing solution 2, and the neural network model implemented in this application. To more intuitively describe differences between the three, FIGS. 10A-10D show images output after an image to which noise with a variance 50 is added is processed using the existing solution 1, the existing solution 2, and the neural network model in this application. FIG. 10A is the image to which the noise with the variance 50 is added, FIG. 10B is a noisy image with the variance 50 that is obtained through processing using the existing solution 1, FIG. 10C is a noisy image with the variance 50 that is obtained through processing using the existing solution 2, and FIG. 10D is a noisy image with the variance 50 that is obtained through processing using the neural network model in this application. It can be learned from FIGS. 10A-10D that, compared with the image obtained through processing in the existing solution 2, the image obtained through processing by the neural network model in this application has lower noise. From a visual perspective, noise of the image obtained through processing using the neural network model in this application is similar to that of the image obtained through processing using the existing solution 1.

In conclusion, in comparison with the existing solutions, a total quantity of weight values in the neural network model provided in this application is reduced, a quantity of data read times is effectively reduced, processing performance is improved, and reliability of the neural network model is relatively high.

After obtaining a neural network model through training using the foregoing training method, the processing apparatus can directly execute a corresponding task using the trained neural network model to implement data processing. Optionally, the processing apparatus may further periodically update the neural network model such that the neural network model better meets an actual requirement.

Further, a data processing method performed by the processing apparatus using the neural network model provided in this application is as follows. After obtaining a first to-be-processed object and receiving a first processing operation that is used to instruct to execute a first task on the first to-be-processed object and that is input by a user, the processing apparatus obtains the t^{th} group of dedicated weight values (weight values uniquely corresponding to the first task), a shared weight value, and first input data (when 1<i≤M, the first input data is data output after the (i−1)^{th} network layer in M network layers processes the first to-be-processed object, or when i=1, the first input data is data of the first to-be-processed object) in the i^{th} network layer, obtains first output data based on the t^{th} group of dedicated weight values, the shared weight value, and the first input data, and then transmits the first output data. Then, after obtaining a second to-be-processed object and receiving a second processing operation that is used to instruct to execute a second task (different from the first task) on the second to-be-processed object and that is input by the user, the processing apparatus obtains the q^{th} (N≥q≥1, and q≠t) group of dedicated weight values and second input data (when 1<i≤M, the second input data is data output after the (i−1)^{th} network layer processes the second to-be-processed object, or when i=1, the second input data is data of the second to-be-processed object) in the i^{th} network layer, obtains second output data based on the q^{th} group of dedicated weight values, the second input data, and the obtained shared weight value, and then transmits the obtained second output data.

It is easy to understand that if the i^{th} network layer is not the last network layer in the neural network model, the transmitting the first output data means sending the first output data to the (i+1)^{th} network layer such that the processing apparatus processes the first output data in the (i+1)^{th} network layer. Similarly, if the i^{th} network layer is not the last network layer in the neural network model, the transmitting the second output data means sending the second output data to the (i+1)^{th} network layer such that the processing apparatus processes the second output data in the (i+1)^{th} network layer.

For example, if both the first to-be-processed image and the second to-be-processed image are images, the first task is an image denoising task, and the second task is an image recognition task, after obtaining a first to-be-processed image and receiving a first processing operation that is used to instruct to execute the image denoising task on the first to-be-processed image and that is input by a user, the processing apparatus obtains the t^{th} group of dedicated weight values (weight values uniquely corresponding to the first task), a shared weight value, and first input data (when 1<i≤M, the first input data is data output after the (i−1)^{th} network layer in M network layers processes the first to-be-processed image, or when i=1, the first input data is data of the first to-be-processed image) in the i^{th} network layer, obtains first output data based on the t^{th} group of dedicated weight values, the shared weight value, and the first input data, and then transmits the first output data. Then, after obtaining a second to-be-processed image and receiving a second processing operation that is used to instruct to execute the image recognition task on the second to-be-processed image and that is input by the user, the processing apparatus obtains the q^{th} (N≥q≥1, and q≠t) group of dedicated weight values and second input data (when 1<i≤M, the second input data is data output after the (i−1)^{th} network layer processes the second to-be-processed image, or when i=1, the second input data is data of the second to-be-processed image) in the i^{th} network layer, obtains second output data based on the q^{th} group of dedicated weight values, the second input data, and the obtained shared weight value, and then transmits the obtained second output data.

It can be learned that during switching between different tasks, the processing apparatus only needs to obtain a dedicated weight value uniquely corresponding to a task to which switching is performed, without re-obtaining all weight values such that a quantity of read times is reduced, and processing efficiency is increased.

An embodiment of this application provides a processing apparatus, and the processing apparatus may be an electronic device. Further, the processing apparatus is configured to perform the steps performed by the processing apparatus in the foregoing data processing method or perform the steps performed by the processing apparatus in the foregoing method for training a neural network model. The processing apparatus provided in this embodiment of this application may include modules corresponding to corresponding steps.

In this embodiment of this application, the processing apparatus may be divided into function modules based on the foregoing method examples. For example, function modules may be obtained through division based on corresponding functions, or two or more functions may be integrated into one processing module. The integrated module may be implemented in a form of hardware, or may be implemented in a form of a software functional module. In this embodiment of this application, module division is exemplary, and is merely a logical function division. In actual implementation, another division manner may be used.

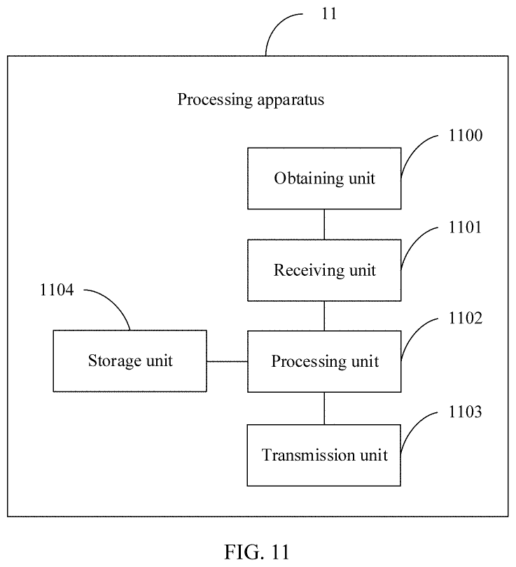

When function modules are obtained through division based on corresponding functions, FIG. 11 is a possible schematic structural diagram of the processing apparatus in the foregoing embodiments. As shown in FIG. 11, a processing apparatus 11 includes an obtaining unit 1100, a receiving unit 1101, a processing unit 1102, and a transmission unit 1103.

The obtaining unit 1100 is configured to support the processing apparatus in performing “obtaining a first to-be-processed image”, “obtaining a second to-be-processed image”, and the like, and/or is configured to perform another process of the technology described in this specification.

The receiving unit 1101 is configured to support the processing apparatus in performing “receiving a first processing operation input by a user”, “receiving a second processing operation input by the user”, and the like, and/or is configured to perform another process of the technology described in this specification.

The processing unit 1102 is configured to support the processing apparatus in performing “obtaining first output data based on the t^{th} group of dedicated weight values, the shared weight value, and the first input data”, “obtaining second output data based on the q^{th} group of dedicated weight values, the second input data, and the obtained shared weight value”, and the like, and/or is configured to perform another process of the technology described in this specification.

The transmission unit 1103 is configured to support the processing apparatus in performing “transmitting the first output data”, “transmitting the second output data”, and the like, and/or is configured to perform another process of the technology described in this specification.

All content related to each step in the foregoing method embodiments may be cited in function description of a corresponding function module. Details are not described herein again.

Certainly, the processing apparatus provided in this embodiment of this application includes but is not limited to the foregoing modules. For example, the processing apparatus may further include a storage unit 1104.

The storage unit 1104 may be configured to store program code and data of the processing apparatus.

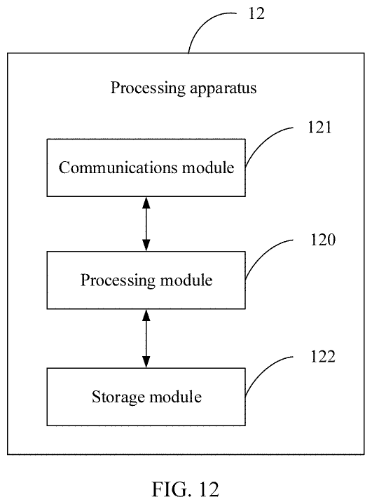

When an integrated unit is used, FIG. 12 is a schematic structural diagram of a processing apparatus according to an embodiment of this application. In FIG. 12, a processing apparatus 12 includes a processing module 120 and a communications module 121. The processing module 120 is configured to control and manage actions of the processing apparatus, for example, perform the steps performed by the obtaining unit 1100 and the processing unit 1102, and/or is configured to perform another process of the technology described in this specification. The communications module 121 is configured to support the processing apparatus in interacting with another device, for example, perform steps performed by the receiving unit 1101 and the transmission unit 1103. As shown in FIG. 12, the processing apparatus may further include a storage module 122, and the storage module 122 is configured to store program code and data of the processing apparatus, for example, store a neural network model.

The processing module 120 may be a processor or controller, for example, the processing module may be a central processing unit (CPU), a general-purpose processor, a digital signal processor (DSP), an application-specific integrated circuit (ASIC), a field-programmable gate array (FPGA) or another programmable logical device, a transistor logical device, a hardware component, or any combination thereof. The processor may implement or execute various example logical blocks, modules, and circuits described with reference to content disclosed in this application. The processor may be a combination of processors implementing a computing function, for example, a combination of one or more microprocessors, or a combination of the DSP and a microprocessor. The communications module 121 may be a transceiver, an RF circuit, a communications interface, or the like. The storage module 122 may be the memory 103.

If the processing apparatus 12 is a mobile phone, the processing module 120 may be the processor 101 in FIG. 2, the communications module 121 may be the antenna in FIG. 2, and the storage module 122 may be the memory in FIG. 2.

Another embodiment of this application further provides a computer readable storage medium. The computer readable storage medium includes one or more pieces of program code. The one or more programs include instructions. When a processor of a processing apparatus executes the program code, the processing apparatus performs the foregoing data processing method.

In another embodiment of this application, a computer program product is further provided. The computer program product includes a computer executable instruction, and the computer executable instruction is stored in a computer readable storage medium. At least one processor of a processing apparatus may read the computer executable instruction from the computer readable storage medium, and when the at least one processor executes the computer executable instruction, the processing apparatus performs the steps of the foregoing data processing method.

All or some of the foregoing embodiments may be implemented by means of software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated.

The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a FLOPPY DISK, a hard disk, or a magnetic tape), an optical medium (for example, a digital versatile disk (DVD)), a semiconductor medium (for example, a solid-state drive (SSD)), or the like.

The foregoing descriptions about implementations allow a person skilled in the art to understand that, for the purpose of convenient and brief description, division of the foregoing function modules is taken as an example for illustration. In actual application, the foregoing functions can be allocated to different modules and implemented according to a requirement, that is, an inner structure of an apparatus is divided into different function modules to implement all or some of the functions described above.

In the several embodiments provided in this application, it should be understood that the disclosed apparatus and method may be implemented in other manners. For example, the described apparatus embodiment is merely exemplary. For example, the module or unit division is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a readable storage medium. Based on such an understanding, the technical solutions of this application essentially, or the part contributing to other approaches, or all or some of the technical solutions may be implemented in the form of a software product. The software product is stored in a storage medium and includes several instructions for instructing a device (which may be a single-chip microcomputer, a chip or the like) or a processor to perform all or some of the steps of the methods described in the embodiments of this application. The foregoing storage medium includes any medium that can store program code, such as a USB flash drive, a removable hard disk, a read-only memory (ROM), a RAM, a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A computer program product comprising a neural network model comprising M network layers and configured to execute N tasks comprising a first task, wherein when executing the first task, an i^{th} network layer in the M network layers causes an apparatus to:
obtain input data;
obtain output data based on a t^{th} group of dedicated weight values corresponding to the first task, a shared weight value that executes each of the N tasks, and the input data, wherein the i^{th} network layer comprises the shared weight value and N groups of dedicated weight values, wherein each of the N groups of dedicated weight values executes one of the N tasks, wherein the N groups of dedicated weight values are in one-to-one correspondence with the N tasks, wherein 1≤i≤M, wherein i is an integer, wherein N is an integer greater than or equal to 2, wherein M is a positive integer, wherein 1≤t≤N, and wherein t is an integer;
transmit the output data to an (i+1)^{th} network layer in the M network layers when 1≤i<M; and
output the output data when i=M.

2. The computer program product of claim 1, wherein the i^{th} network layer is a convolutional layer.

3. The computer program product of claim 1, wherein the i^{th} network layer is a fully connected layer.

4. The computer program product of claim 1, wherein the i^{th} network layer is a deconvolution layer.

5. The computer program product of claim 1, wherein the i^{th} network layer is a recurrent layer.

6. The computer program product of claim 1, wherein the output data comprises shared output data and dedicated output data, and wherein when the i^{th} network layer is a convolutional layer, the i^{th} network layer further causes the apparatus to:
perform a first convolution calculation on the input data using the shared weight value to obtain the shared output data; and
perform a second convolution calculation on the input data using the t^{th} group of dedicated weight values to obtain the dedicated output data.

7. The computer program product of claim 1, wherein the output data comprises shared output data and dedicated output data, and wherein when the i^{th} network layer is a fully connected layer, the i^{th} network layer further causes the apparatus to:
perform a first multiply-add calculation on the input data using the shared weight value to obtain the shared output data; and
perform a second multiply-add calculation on the input data using the t^{th} group of dedicated weight values to obtain the dedicated output data.

8. The computer program product of claim 1, wherein the output data comprises shared output data and dedicated output data, and wherein when the i^{th} network layer is a deconvolution layer, the i^{th} network layer further causes the apparatus to:
perform a first transposed convolution calculation on the input data using the shared weight value to obtain the shared output data; and
perform a second transposed convolution calculation on the input data using the t^{th} group of dedicated weight values to obtain the dedicated output data.

9. A data processing method comprising:
obtaining a first to-be-processed object;
receiving, from a user, a first processing operation instructing execution of a first task on the first to-be-processed object;
obtaining, in response to the first processing operation, a t^{th} group of dedicated weight values, a shared weight value, and first input data in an i^{th} network layer, wherein the first input data is either data output after an (i−1)^{th} network layer in M network layers processes the first to-be-processed object when 1<i≤M or data of the first to-be-processed object when i=1;
obtaining first output data based on the t^{th} group of dedicated weight values, the shared weight value, and the first input data;
transmitting the first output data;
obtaining a second to-be-processed object;
receiving, from the user, a second processing operation instructing execution of a second task on the second to-be-processed object, wherein the second task is one of N tasks and is different from the first task; and
obtaining, in response to the second processing operation, a q^{th} group of dedicated weight values and second input data in the i^{th} network layer, wherein the q^{th} group of dedicated weight values are in the i^{th} network layer that uniquely correspond to the second task, wherein N≥q≥1, wherein q≠t, wherein q is an integer, and wherein the second input data is either data output after the (i−1)^{th} network layer processes the second to-be-processed object when 1<i≤M or data of the second to-be-processed object when i=1;
obtaining second output data based on the q^{th} group of dedicated weight values, the second input data, and the shared weight value; and
transmitting the second output data.

10. The data processing method of claim 9, wherein the first output data comprises shared output data and dedicated output data, and wherein when the i^{th} network layer is a convolutional layer, the data processing method further comprises:
performing a first convolution calculation on the first input data using the shared weight value to obtain the shared output data; and
performing a second convolution calculation on the first input data using the t^{th} group of dedicated weight values to obtain the dedicated output data.

11. The data processing method of claim 9, wherein the first output data comprises shared output data and dedicated output data, and wherein when the i^{th} network layer is a fully connected layer, the data processing method further comprises:
performing a first multiply-add calculation on the first input data using the shared weight value to obtain the shared output data; and
performing a second multiply-add calculation on the first input data using the t^{th} group of dedicated weight values to obtain the dedicated output data.

12. The data processing method of claim 9, wherein the first output data comprises shared output data and dedicated output data, and wherein when the i^{th} network layer is a deconvolution layer, the data processing method further comprises:
performing a first transposed convolution calculation on the first input data using the shared weight value to obtain the shared output data; and
performing a second transposed convolution calculation on the first input data using the t^{th} group of dedicated weight values to obtain the dedicated output data.

13. A computer program product comprising computer-executable instructions for storage on a non-transitory computer-readable medium that, when executed by a processor, cause an apparatus to:
obtain a first to-be-processed image;
receive, from a user, a first processing operation instructing execution of an image denoising task on the first to-be-processed image;
obtain, in response to the first processing operation, a t^{th} group of dedicated weight values, a shared weight value, and first input data in an i^{th} network layer, wherein the first input data is either data output after an (i−1)^{th} network layer in M network layers processes the first to-be-processed image when 1<i≤M or data of the first to-be-processed image when i=1;
obtain first output data based on the t^{th} group of dedicated weight values, the shared weight value, and the first input data;
transmit the first output data;
obtain a second to-be-processed image;
receive, from the user, a second processing operation instructing execution of an image recognition task on the second to-be-processed image, wherein the image recognition task is one of N tasks;
obtain, in response to the second processing operation, a q^{th} group of dedicated weight values and second input data in the i^{th} network layer, wherein the q^{th} group of dedicated weight values are in the i^{th} network layer that uniquely correspond to the image recognition task, wherein N≥q≥1, wherein q≠t, wherein q is an integer, and wherein the second input data is either data output after the (i−1)^{th} network layer processes the second to-be-processed image when 1<i≤M or data of the second to-be-processed image when i=1;
obtain second output data based on the q^{th} group of dedicated weight values, the second input data, and the shared weight value; and
transmit the second output data.

14. The computer program product of claim 13, wherein the first output data comprises shared output data and dedicated output data, and wherein when the i^{th} network layer is a convolutional layer, the computer-executable instructions further causes the apparatus to:
perform a first convolution calculation on the first input data using the shared weight value to obtain the shared output data; and
perform a second convolution calculation on the first input data using the t^{th} group of dedicated weight values to obtain the dedicated output data.

15. The computer program product of claim 13, wherein the first output data comprises shared output data and dedicated output data, and wherein when the i^{th} network layer is a deconvolution layer, the computer-executable instructions further causes the apparatus to:
perform a first transposed convolution calculation on the first input data using the shared weight value to obtain the shared output data; and
perform a second transposed convolution calculation on the first input data using the t^{th} group of dedicated weight values to obtain the dedicated output data.

16. The computer program product of claim 13, wherein the first output data comprises shared output data and dedicated output data, and wherein when the i^{th} network layer is a fully connected layer, the computer-executable instructions further causes the apparatus to:
perform a first multiply-add calculation on the first input data using the shared weight value to obtain the shared output data; and
perform a second multiply-add calculation on the first input data using the t^{th} group of dedicated weight values to obtain the dedicated output data.

17. The computer program product of claim 13, wherein the i^{th} network layer is a fully connected layer.

18. The computer program product of claim 13, wherein the i^{th} network layer is a deconvolution layer.

19. The computer program product of claim 13, wherein the i^{th} network layer is a recurrent layer.

20. The computer program product of claim 13, wherein the i^{th} network layer is a convolutional layer.
